(19) United States
(12) Patent Application Publication
(10) Pub. No.: US 2005/0225970 A1
(43) Pub. Date: Oct. 13, 2005

(54) Compartment for incorporation within a flashlight handle

(76) Inventors: Shane A. Molthop, Salinas, CA (US); Carl J. Clark, Salinas, CA (US)

Correspondence Address: RICHARD L. MILLER, 12 PARKSIDE DRIVE, DIX HILLS, NY, 11746, US

(21) Appl. No.: 10/818,288

(22) Filed: Apr. 5, 2004

(51) Int. Cl. F21L 2/00; F21L 4/04

(52) U.S. Cl. 362/202

(57) ABSTRACT

A compartment for threadably replacing a flashlight battery holding handle end cap of a flashlight. A housing holds tools and has a collar on a proximal end thereof that screws the housing into the flashlight where the flashlight battery holding handle end cap was removed from. A coil spring sits coaxially in the collar and provides a negative contact previously provided by the flashlight battery holding handle end cap. A distal end of the housing threadably receives the flashlight battery holding handle end cap. The housing has a plurality of through bores allowing viewing into the compartment. A transparent removable jar is snugly contained in the housing and closes off the plurality of through bores and thereby waterproofs the housing, while allowing viewing therethrough.

### BACKGROUND OF THE INVENTION

1. Field of the Invention

The present invention relates to a compartment. More particularly, the present invention relates to a compartment for incorporating into the handle of a flashlight which is suitable for holding tools, fasteners, bait, biological specimens and other items, which is threadably placed between a flashlight battery holding handle end cap of a flashlight and a flashlight.

2. Description of the Prior Art

Numerous innovations for flashlight attaching devices have been provided in the prior art that will be described. Even though these innovations may be suitable for the specific individual purposes to which they address, however, they differ from the present invention.

A FIRST EXAMPLE, U.S. Pat. No. 1,648,709 to Winsell teaches a lamp comprising a cylindrical casing, a cap on one end of the cashing having a conical, closed end provided with a reflecting surface and a lamp socket concentric with the closed end, a lamp bulb in the socket and a sleeve slidably mounted on the casing having a flared outer end movable into concentric overlapping relation with the conical reflector for the purpose set forth, the sleeve having means thereon engaging the cap to limit the movement thereof.

A SECOND EXAMPLE, U.S. Pat. No. 3,710,092 to Olbermann, Jr. teaches a multi-section flashlight with an auxiliary compartment which screws onto the battery holder provides space for service, first aid or survival items or the like making a unitary flashlight and aid or survival kit. The rear threads on the auxiliary compartment so that an end cap can be alternatively screwed on the battery holder and compartment.

A THIRD EXAMPLE, U.S. Pat. No. 3,890,498 to Toth, Sr. teaches a flashlight device of the type for use with one or more battery cells including a main body member having a switch actuatable light assembly. Two or more barrel members having threaded connections are interchangeably connectable with the main body member for increasing the battery cell capacity and length of the device, and an end cap assembly including a detachable fastener element for mounting a hand carrying member is threadable interchangeable for use with the main body or barrel members during normal use thereof. The end cap assembly has a compartment-like recess therein in which the fastener element may be selectively disposed.

A FOURTH EXAMPLE, U.S. Pat. No. 5,190,369 to Pace teaches a device that attaches to a flashlight and makes the flashlight a cordless trouble-light. The invention consists of an outer cylindrical shell with a closed top and open bottom. The open bottom is threaded so that it can be screwed onto the lamp of a flashlight so designed for this concept. In the front of the cylindrical shell is a clear window. Within the shell and behind the clear window is a mirror that is adapted so that when the light source from the flashlight shines upon the mirror, the mirror reflects toward the clear window. A plastic snap-on shield is placed over the clear window for protection. The snap-on shield can be removed for easy cleaning of the window.

A FIFTH EXAMPLE, U.S. Pat. No. 5,197,796 to Moore teaches a conventional flashlight which is modified to provide greater brightness by providing an extension tube between the base cap and the body of the flashlight. The extension holds one or more additional batteries so that a higher voltage and brighter bulb can be substituted for the original flashlight bulb. In a preferred embodiment, the extension has the same outer diameter as the body of the original flashlight so that it fits in the same mounts as the original flashlight. Where the flashlight body and the extension have a thin sidewall surrounding the batteries so that there is insufficient thickness available to form threads in the sidewall of the portion of the extension that mates with the body and still leave room for a battery to pass through, then the battery in the extension is spaced away from that end and a cylindrical insulated bushing with an axial electrical conductor is provided therein to make electrical connection between the battery in the extension and the battery in the body. A longer and more powerful flashlight is obtained with no wasted parts, and which accepts a higher voltage, brighter light bulb.

A SIXTH EXAMPLE, U.S. Pat. No. 5,577,829 to Hall teaches a flashlight with a tool mounting stud that is configured to receive a plurality of different types of commonly available tool bits. The tool mounting stud is positioned at substantially the center of a focusing lens of the flashlight and is retained in this position by a plurality of spokes which are connected to a lip formed around the outer surface of the focusing lens. The lens assembly of the flashlight is secured in position by a securing device which prevents rotation of the lens assembly relative the body of the flashlight during manipulation of a fastener by a user using the flashlight tool. In one embodiment, the securing device is comprised of at least one set screw which engages with both the lens assembly and the body to prevent rotation of the lens assembly. In another embodiment, the securing device is comprised of a groove formed on a section of the body and a tab formed on a section of the lens assembly which interact to inhibit rotation of the lens assembly.

A SEVENTH EXAMPLE, U.S. Patent Application Publication No. 2002/0006038 A1 to Fladung teaches a device for coupling to a battery operated flashlight comprising a window breaking implement, and a cutting implement, which can be a cap for covering the battery compartment of the flashlight. A thread can be provided for screw-type attachment to the flashlight and wherein the window breaking implement is arranged on a surface of the device which faces the surface provided for attachment to the flashlight. The window breaking implement can be centrally located in the device or cap and includes a striking pin at one end to break glass. The cutting implement consists of one or more blades located in a narrow recess in the device so as to cut seat belts or other thin fabric materials. Thus, the device can be provided to emergency personnel for use in car accidents to help evacuate passengers.

It is apparent that numerous innovations for flashlight attaching devices have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a compartment for threadably replacing a flashlight battery holding handle end cap of a flashlight that avoids the disadvantages of the prior art.

ANOTHER OBJECT of the present invention is to provide a compartment for threadably replacing a flashlight battery holding handle end cap of a flashlight that is simple to use.

BRIEFLY STATED, STILL ANOTHER OBJECT of the present invention is to provide a compartment for threadably replacing a flashlight battery holding handle end cap of a flashlight. A housing holds items and has a collar on a proximal end thereof that screws the housing into the flashlight where the flashlight battery holding handle end cap was removed from. A coil spring sits coaxially in the collar and provides a negative contact previously provided by the flashlight battery holding handle end cap. A distal end of the housing threadably receives the flashlight battery holding handle end cap. The housing has a plurality of through bores allowing viewing into the compartment. A transparent removable Jar is snugly contained in the housing and closes off the plurality of through bores and thereby waterproofs the housing, while allowing viewing therethrough, and preventing very small items from being lost through the bores. If desired the removable jar may be removed from the compartment so as to permit the holding of live specimen, bait, small animals and insects which require air to breath in order to be maintained alive.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic side elevational view of the present invention threadably replacing a flashlight battery holding handle end cap of a flashlight;

FIG. 3 is an enlarged diagrammatic side elevational view of the are generally enclosed by the dotted curve identified by ARROW 2 in FIG. 1 of the present invention; and

FIG. 3 is a diagrammatic cross sectional view taken along LINE 3-3 in FIG. 2.

### LIST OF REFERENCE NUMERALS UTILIZED IN THE DRAWING

10 compartment of present invention for threadably replacing flashlight battery holding handle end cap 12
12 flashlight battery holding handle end cap
13 flashlight
14 housing for holding tools (not shown) and for threadably replacing flashlight battery holding handle end cap 12
16 proximal end of housing 14
18 distal end of housing 14
20 collar
21 external threads on collar 20 for screwing into where flashlight battery holding handle end cap 12 was removed from
22 coil spring for providing negative contact previously provided by flashlight battery holding handle end cap 12
23 internal threads on distal end 18 of housing 14 for threadably receiving flashlight battery holding handle end cap 12
24 plurality of through bores through housing 14
26 removable jar

### DETAILED DESCRIPTION OF THE PREFERRED EMBODIMENT

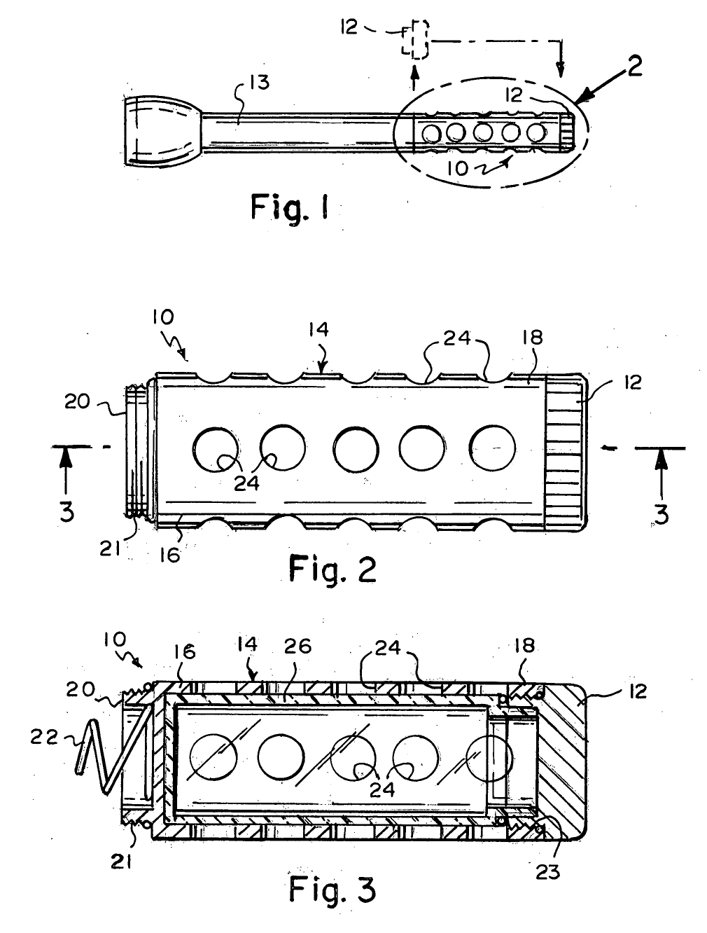

Referring now to the figures, in which like numerals indicate like parts, and particularly to FIG. 1, the compartment of the present invention is shown generally at 10 for threadably replacing a flashlight battery holding handle end cap 12 of a flashlight 13.

The configuration of the compartment can best be seen in FIGS. 2 and 3, and as such, will be discussed with reference thereto.

The compartment 10 comprises a housing 14. The housing 14 is for holding tools (not shown) and for threadably replacing the flashlight battery holding handle end cap 12 of a flashlight 13.

The housing 14 is cylindrically-shaped and hollow, and has a proximal end 16 and a distal end 18.

The proximal end 16 of the housing 14 is closed.

The compartment 10 further has a collar 20. The collar 20 extends coaxially from the proximal end 16 of the housing 14.

The collar 20 is reduced from the proximal end 16 of the housing 14 and has external threads 21 thereon for screwing into the flashlight 13, where the flashlight battery holding handle end cap 12 was removed from.

The compartment 10 further comprises a coil spring 22. The coil spring 22 sits coaxially in the collar 22 for providing a negative contact previously provided by the flashlight battery holding handle end cap 12.

The distal end 18 of the housing 14 is open, and has internal threads 23 thereon for threadably receiving the flashlight battery holding handle end cap 12.

The housing 14 has a plurality of through bores 24. The plurality of through bores 24 extend laterally through the housing 14 and allow viewing into the compartment 10.

The compartment 10 further comprises a removable jar 26. The removable jar 26 is cylindrically-shaped, and is snugly contained in the housing 14 to close off the plurality of through bores 24 through the housing 14 and thereby waterproof the housing 14.

The removable jar 26 is snugly contained in the housing 14 by being abutted against the flashlight battery holding handle end cap 12 when the flashlight battery holding handle end cap 12 is installed in the distal end 18 of the housing 14.

The removable jar 26 is transparent so as to allow viewing into the housing 14 once the removable jar 26 has closed off the plurality of through bores 24 through the housing 14.

It will be understood that each of the elements described above, or two or more together, may also find a useful application in other types of constructions differing from the types described above.

While the invention has been illustrated and described as embodied in a compartment for threadably replacing a flashlight battery holding handle end cap, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. A compartment for threadably replacing a flashlight battery holding handle end cap of a flashlight, comprising:
a housing;
wherein said housing is for threadably replacing the flashlight battery holding handle end cap of the flashlight; and
wherein said housing is for holding tools.

2. The compartment as defined in claim 1, wherein said housing is cylindrically-shaped; and
wherein said handle is hollow.

3. The compartment as defined in claim 1, wherein said handle has a proximal end; and
wherein said handle has a distal end.

4. The compartment as defined in claim 3, wherein said proximal end of said housing is closed.

5. The compartment as defined in claim 4; further comprising a collar;
wherein said collar extends coaxially from said proximal end of said housing.

6. The compartment as defined in claim 5, wherein said collar is reduced from said proximal end of said housing.

7. The compartment as defined in claim 5, wherein said collar has external threads thereon; and
wherein said external threads on said collar are for screwing into the flashlight where the flashlight battery holding handle end cap was removed from.

8. The compartment as defined in claim 5; further comprising a coil spring;
wherein said coil spring sits coaxially in said collar; and
wherein said coil spring is for providing a negative contact previously provided by the flashlight battery holding handle end cap.

9. The compartment as defined in claim 3, wherein said distal end of said housing is open.

10. The compartment as defined in claim 3, wherein said distal end of said housing has internal threads thereon; and
wherein said internal threads on said distal end of said housing are for threadably receiving the flashlight battery holding handle end cap.

11. The compartment as defined in claim 3, wherein said housing has a plurality of through bores;
wherein said plurality of through bores extend laterally through said housing; and
wherein said plurality of through bores through said housing allow viewing into said compartment.

12. The compartment as defined in claim 11; further comprising a removable jar;
wherein said removable jar is snugly contained in said housing; and
wherein said removable jar closes off said plurality of through bores through said housing and thereby waterproof said housing.

13. The compartment as defined in claim 12, wherein said removable jar is cylindrically-shaped.

14. The compartment as defined in claim 12, wherein said removable jar is snugly contained in said housing by being abutted against the flashlight battery holding handle end cap when the flashlight battery holding handle end cap is installed in said distal end of said housing.

15. The compartment as defined in claim 12, wherein said removable jar is transparent so as to allow viewing into said housing once said removable jar has closed off said plurality of through bores through said housing.
